(19) United States
(12) Patent Application Publication
(10) Pub. No.: US 2025/0360487 A1
(43) Pub. Date: Nov. 27, 2025

(54) HoMOF MATERIAL ITS PREPARATION METHODS AND ITS APPLICATIONS

(71) Applicants: Panjin Institute of Industrial Technology, Dalian University of Technology, Panjin (CN); Shanghai Polytechnic University, Shanghai (CN)

(72) Inventors: Yonghou XIAO, Panjin (CN); Jin YAN, Panjin (CN); Shuohan YANG, Panjin (CN); Yushan LI, Panjin (CN); Zhengqi LIANG, Panjin (CN); Xu LIU, Panjin (CN); Boxing AN, Panjin (CN)

(21) Appl. No.: 18/817,134

(22) Filed: Aug. 27, 2024

(30) Foreign Application Priority Data
May 24, 2024 (CN) 202410652496.4

(51) Int. Cl. B01J 20/22; B01J 20/28; B01J 20/30; B01J 20/32; C02F 1/28; C02F 101/30

(52) U.S. Cl. CPC B01J 20/226; B01J 20/28059; B01J 20/28061; B01J 20/28071; B01J 20/28083; B01J 20/3078; B01J 20/3208; B01J 20/3236; C02F 1/288; C02F 2101/308

(57) ABSTRACT

The present invention discloses a HoMOF material, its preparation method and its application, which comprises: (1) mixing a holmium source, organic ligand and solvent, sonicating to obtain the first mixture; (2) Placing the first mixture in the condensation reflux device for heating and stirring to obtain the second mixture; (3) Post treating the second mixture to obtain HoMOF material. Therefore, the preparation method is facile, and the obtained HoMOF material has a uniform pore structure, fewer impurity peaks, a single structure, good crystal structure and good magnetism, which can be further applied to adsorb methylene blue from waste water.

### CROSS-REFERENCE TO RELATED APPLICATIONS

This application claims priority of Chinese Patent Application No. 202410652496.4, filed on May 24, 2024, the entire contents of which are incorporated herein by reference.

### TECHNICAL FIELD

The present invention relates to the technical field of metal organic framework materials, specifically to one kind of HoMOF material and its preparation method as well as its application.

### BACKGROUND TECHNOLOGY

Metal organic framework functional porous materials (MOFs) possess unique application value in many fields and have always been a research focus for researchers. Although some preparation methods for metal organic framework materials have been reported in previous literature, their preparation process is often complex or requires high temperature and pressure.

The current methods for treatment of printing and dyeing wastewater can be divided into three categories: chemical, biological, and physical methods. In actual treatment of printing and dyeing wastewater, different methods often need to be selected according to the actual situation. Chemical methods could mainly treat pollutants in wastewater through redox reactions, including electrochemical and oxidation methods. Biological method refers to the method of using the metabolic process of microorganisms themselves to degrade organic pollutants, which are mainly divided into aerobic methods and anaerobic methods. Physical methods mainly include adsorption, membrane separation, flocculation and sedimentation and ion exchange. Among them, adsorption method is a method of using solid adsorbent to adsorb one or more components in the liquid phase on the surface, achieving component separation and enrichment. The adsorption method is simple to operate, has a wide range of applications, and it has a removal effect on various pollutants present in wastewater, making it the most commonly used and widely concerned sewage treatment methods.

Chinese patent CN107930573A discloses an adsorbent for removing methylene blue, which is composed of minerals and organic matter. After modification, the adsorbent structure becomes loose, the specific surface area increases, the number of active groups increases, and the pore as well as void structures are improved. It has high affinity and adsorption selectivity for methylene blue. Chinese patent CN109179557A discloses a method for preparing inorganic lanthanum hexaborate as a methylene blue adsorbent material. Lanthanum chloride and sodium borohydride are used as reactants, and zinc is used as a medium to synthesize lanthanum hexaborate nanomaterials at low temperatures. The lanthanum hexaborate powder synthesized by low-temperature melting method has small particle size and many surface interface defects, achieving the purpose of adsorbing methylene blue in wastewater. U.S. Ser. No. 10/745,294B2 discloses a novel graphene oxide/magnesium oxide nanocomposite material synthesized by impregnation using graphene oxide and magnesium oxide nanoparticles as raw materials, which makes graphene oxide easy to precipitate in aqueous solution and achieve the goal of adsorbing methylene blue. U.S. Ser. No. 11/369,943B2 discloses a method for preparing biodegradable modified starch, which is used as a methylene blue adsorbent. After modification, the adsorbent has a large specific surface area, enhanced adsorption capacity and selectivity, and is conducive to the absorption of methylene blue.

In summary, although some adsorbents for removing methylene blue have been reported in previous literature, existing adsorbents have the following problems: a. complex preparation process; b. The adsorption capacity of methyl blue is low, and the adsorption rate is slow.

### CONTENT OF THE INVENTION

The present invention aims to solve one of the technical problems in the relevant technology to a certain extent. One purpose of the present invention is to propose a HoMOF material and its preparation method as well as application.

In one aspect of the present invention, a method for preparing HoMOF materials is proposed. According to the embodiments of the present invention, the method comprises:
(1) Mixing the holmium source, organic ligand and solvent, sonicating to obtain the first mixture;
(2) Placing the first mixture in the condensation reflux device for heating and stirring to obtain the second mixture;
(3) Post treating the second mixture to obtain HoMOF material.

In some embodiments, the mole ratio of the holmium source, organic ligand, and solvent mixture is (1.5˜2.5):(0.8˜1.2):(1˜5).

In some embodiments, the temperature of the ultrasound is 20˜30° C. and the time is 15˜30 minutes.

In some embodiments, in step (1), the holmium source comprises holmium chloride hexahydrate or holmium sulfate octahydrate.

In some embodiments, the organic ligands include one or more of terephthalic acid, 1,2,4-benzenetricarboxylic acid, phthalic acid, isophthalic acid, and terephthalic acid.

In some embodiments, the solvent includes water or ethanol.

In some embodiments, the solvent comprises water and N,N-dimethylformamide, wherein N,N-dimethylformamide accounts for less than 8 wt % of the total mass of water and N,N-dimethylformamide, preferably less than 70 wt %.

In some embodiments, the solvent comprises ethanol and N,N-dimethylformamide, wherein N,N-dimethylformamide accounts for less than 80 wt % of the total mass of ethanol and N,N-dimethylformamide, preferably less than 70 wt %.

In some embodiments, the heating and stirring temperature is 90˜100° C. and the time is 12˜36 h.

In some embodiments, the post-treatment includes: placing the second mixture into a filter, filtering and washing it with anhydrous ethanol, and then drying it in a vacuum drying oven at 100˜120° C. for 3˜6 h.

In the second aspect of the present invention, a HoMOF material is proposed, and according to the embodiments of the present invention, the HoMOF material is prepared using the method described in the first aspect of the present invention.

In some embodiments, the pore volume of the HoMOF material is 0.03˜0.13 cm³/g, the specific surface area is 36˜135 m²/g, and the pore size is 2.33˜15.35 nm.

In the third aspect of the present invention, an application of the HoMOF material described in the second aspect of the present invention is proposed. According to the embodiments of the present invention, the application comprises removing methylene blue.

In some embodiments, the concentration of the methylene blue solution is 2˜2000 ppmw.

The present invention has the following beneficial effects:
(1) The present invention uses a cold and hot reflux device to further synthesize metal organic framework materials under atmospheric pressure, thereby solving the problems of the complex preparation process of metal organic framework materials and the need to be carried out under high temperature and high pressure in the prior art.
(2) The HoMOF material prepared by the present invention has good application prospects in the field affected by magnetism due to the doping of holmium element in the preparation, which makes the material have a certain degree of magnetism.
(3) The present invention solves the problem of unstable crystal structure in MOF materials prepared by organic ligands and divalent ions, and can generate better crystal forms. The obtained MOF materials have uniform pore structure, fewer impurity peaks, a single structure, and a good crystal form.
(4) The HoMOF material provided by the present invention can further serve as an adsorbent for methylene blue, with high adsorption capacity and fast adsorption rate.

The additional aspects and advantages of the present invention will be partially provided in the following description, which will become apparent from the following description, or will be understood through the practice of the present invention.

The above and/or additional aspects and advantages of the present invention will become apparent and easy to understand from the description of embodiments taken in conjunction with the following drawings, wherein:

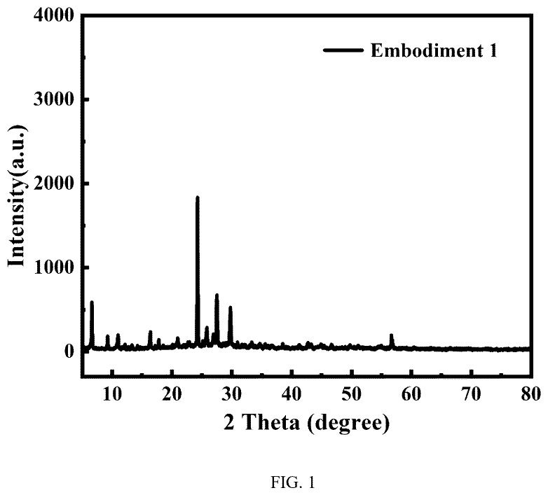

FIG. 1 is the XRD image of the HoMOF material prepared in embodiment 1;

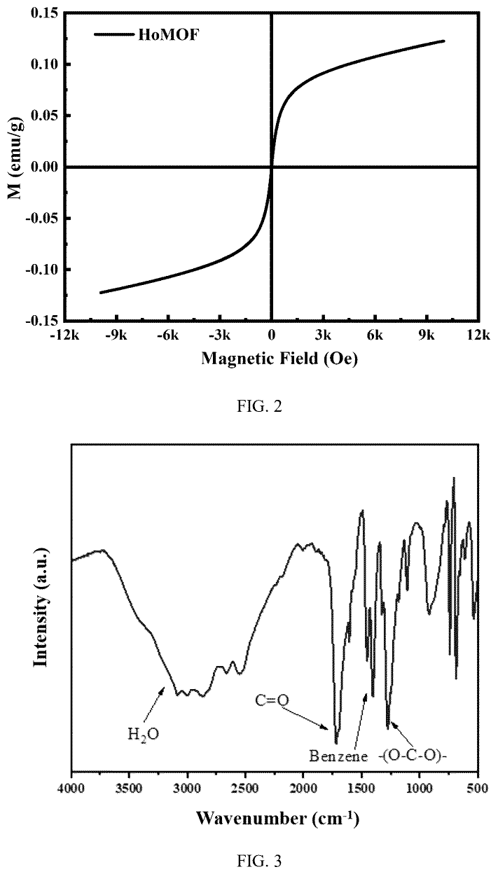

FIG. 2 is the VSM diagram of the HoMOF material prepared in embodiment 1;

FIG. 3 is the FT-IR image of the HoMOF material prepared in embodiment 1;

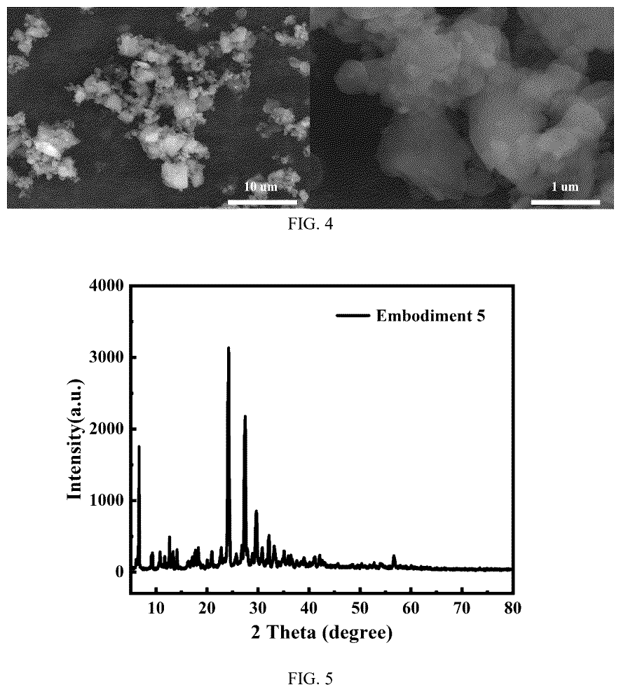

FIG. 4 is an SEM image of the HoMOF material prepared in embodiment 1;

FIG. 5 is the XRD image of the HoMOF material prepared in embodiment 5;

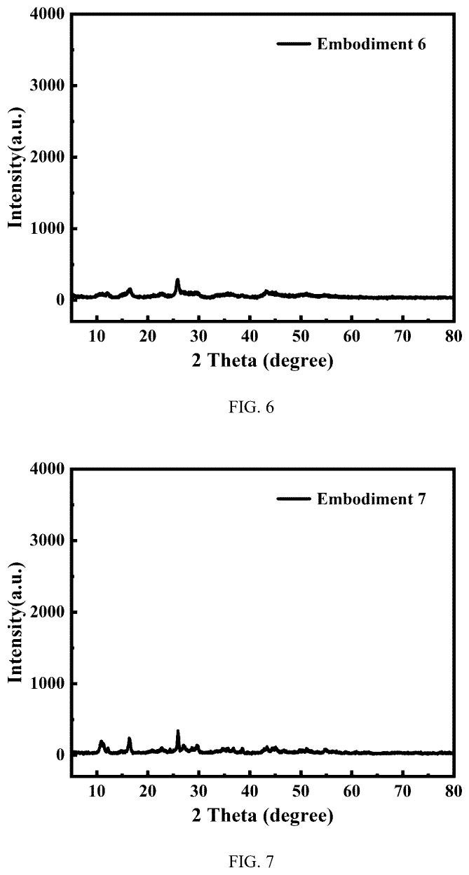

FIG. 6 is the XRD image of the HoMOF material prepared in embodiment 6;

FIG. 7 is the XRD image of the HoMOF material prepared in embodiment 7;

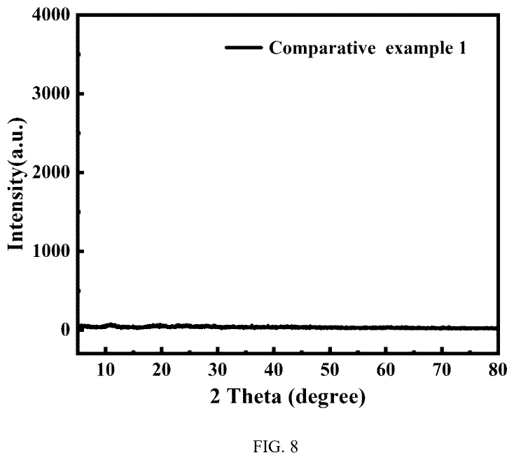

FIG. 8 shows the XRD pattern of HoMOF material prepared in proportional 1.

### SPECIFIC IMPLEMENTATION METHODS

The following describes the embodiments of the present invention in detail, examples of which are shown in the accompanying drawings. The embodiments described below by referring to the accompanying drawings are exemplary and intended to explain the present invention, but cannot be understood as limitations to the present invention.

### Embodiment 1

Dissolving 1.9 g of hexahydrate holmium chloride and 1 g of benzoic acid in 3 mL of water, and sonicate at room temperature for 15 minutes to obtain mixture A. Place mixture A in the condensation reflux device, heat and stir at 95° C. for 24 h to obtain mixture B. Filter, wash, vacuum dry and grind mixture B to obtain material A. The yield of this preparation method is 97%. Its pore volume is 0.13 cm³/g, specific surface area is 135 m²/g, and average pore size is 2.33 nm.

As shown in FIGS. 1˜4, material A was subjected to XRD VSM, FT-IR, SEM characterization. From FIG. 1, it can be seen that material A has good crystallinity, with strong diffraction peaks at 2θ=7.8°, 24.5°, 27.5°, 29.7°, 56.7°. As shown in FIG. 2, the saturation magnetization of material A is 0.125 emu/g, exhibiting typical paramagnetism. As shown in FIG. 3, the organic ligand bound to the central metal ion remains unchanged during the synthesis process. As shown in FIG. 4, material A has a layered structure.

### Embodiment 2

Dissolving 2.5 g of hexahydrate holmium chloride and 1.2 g of benzoic acid in 5 mL of water, other conditions were the same as in example1, to obtain Material B. The yield of this preparation method is 82%, with a pore volume of 0.06 cm³/g, a specific surface area of 83 m²/g, and an average pore size of 9.34 nm.

### Embodiment 3

Placing the mixture A in the condensation reflux device, heating and stirring at 100° C. for 24 h to obtain mixture B, other conditions were the same as in example1, to obtain material C. The yield of this preparation method is 79%, with a pore volume of 0.08 cm³/g, a specific surface area of 92 m²/g, and an average pore size of 7.62 nm.

### Embodiment 4

Dissolving 1.9 g of hexahydrate holmium chloride and 1 g of phthalic acid in 3 mL of water, other conditions were the same as in example 1, to obtain Material D. The yield of this preparation method is 85%, with a pore volume of 0.10 cm³/g, a specific surface area of 116 m²/g, and an average pore size of 4.69 nm.

### Embodiment 5

Dissolving 1.9 g of hexahydrate holmium chloride and 1 g of benzoic acid in 1.5 mL of ethanol and 1.5 mL of water, other conditions were the same as in example 1, to obtain material E. The yield of this preparation method is 90%.

Material E was characterized by XRD, as shown in FIG. 5, and its crystallinity was significantly lower than that of material A, with multiple impurity peaks. Its pore volume is 0.09 cm³/g, specific surface area is 109 m²/g, and average pore size is 5.77 nm.

### Embodiment 6

Dissolving 1.9 g of hexahydrate holmium chloride and 1 g of benzoic acid in 1.5 mL of water and 1.5 mL of DMF, other conditions were the same as in example 1, to obtain material F. The yield of this preparation method is 46%.

Material F was characterized by XRD, as shown in FIG. 6, and its crystallinity was significantly lower than that of material A. Its pore volume is 0.05 cm³/g, specific surface area is 51 m²/g, and average pore size is 12.57 nm.

### Embodiment 7

Dissolving 1.9 g of hexahydrate holmium chloride and 1 g of benzoic acid in 1.5 mL of ethanol and 1.5 mL of DMF, other conditions were the same as in example 1, to obtain material G. The yield of this preparation method is 55%.

Material G was characterized by XRD, as shown in FIG. 7, and its crystallinity was significantly lower than that of material A. Its pore volume is 0.07 cm³/g, specific surface area is 84 m²/g, and average pore size is 9.18 nm.

### Proportion1

Dissolving 1.9 g of hexahydrate holmium chloride and 1 g of benzoic acid in 3 mL of DMF, and other conditions were the same as in example 1, but crystals cannot be generated.

### Proportion 2

Dissolving 1.9 g of hexahydrate holmium chloride and 1 g of benzoic acid in 3 mL of water, and sonicate at room temperature for 15 minutes to obtain a mixture. Transfer the mixture to a hydrothermal reactor and crystallize at 95° C. for 24 h. After cooling, filtering, washing, vacuuming dry and grinding the mixture to obtain material I. The yield of this preparation method is 13%. Its pore volume is 0.03 cm³/g, specific surface area is 36 m²/g, and average pore size is 15.35 nm.

### Proportion 3

Dissolving 0.5 g of hexahydrate holmium chloride and 0.1 g of benzoic acid in 0.5 mL of water, and other conditions were the same as in example 1, crystals cannot be generated.

### Proportion 4

Placing mixture A in the condensation reflux device, heating and stirring at 50° C. for 48 h to obtain mixture B. and other conditions were the same as in example 1, crystals cannot be generated.

The above materials obtained in embodiments and proportional will be used for the methyl blue adsorption experiment, with specific experimental conditions as follows:

Using a UV visible spectrophotometer to detect the concentration of methylene blue solution. At 25° C., place more than 0.04 g of the embodiments and proportional of the obtained material in 40 mL of methylene blue solution, and measure the concentration of methylene blue in the solution at intervals until adsorption equilibrium is reached. The experimental results are shown in Tables 1˜2 (the methylene blue solution in Table 1 is 100 ppmw, and the methylene blue solution in Table 2 is 1000 ppmw):

TABLE 1

| | Methylene blue adsorption | Adsorption equilibrium |
|---|---|---|
| | capacity(mg/g) | time (min) |
| embodiment1 | 100 | 20 |
| embodiment2 | 63.99 | 57 |
| embodiment3 | 72.32 | 50 |
| embodiment4 | 89.86 | 34 |
| embodiment5 | 82.86 | 39 |
| embodiment6 | 41.78 | 71 |
| embodiment7 | 59.61 | 65 |
| proportional1 | 0 | / |
| proportional2 | 39.32 | 83 |
| proportional3 | 0 | / |
| proportional4 | 0 | / |

TABLE 2

| | Methylene blue adsorption | Adsorption equilibrium |
|---|---|---|
| | capacity(mg/g) | time (min) |
| embodiment1 | 989.70 | 60 |
| embodiment2 | 601.5 | 93 |
| embodiment3 | 649.3 | 90 |
| embodiment4 | 736.2 | 75 |
| embodiment5 | 715.8 | 82 |
| embodiment6 | 340.7 | 126 |
| embodiment7 | 494.3 | 107 |
| proportional1 | 0 | / |
| proportional2 | 326.1 | 132 |
| proportional3 | 0 | / |
| proportional4 | 0 | / |

In the description of this instructions, reference to terms such as “one embodiment”, “some embodiments”, “examples”, “specific examples”, or “some examples” means that the specific features, structures, materials, or features described in conjunction with the embodiments or examples are included in at least one embodiment or example of the present invention.

In this manual, the illustrative expressions of the above terms do not necessarily refer to the same embodiments or examples. Moreover, the specific features, structures, materials, or features can be combined in an appropriate manner in any one or more embodiments or examples. In addition, technicians in the field may combine and integrate the different embodiments or examples described in this instructions or examples, without conflicting with each other.

Although embodiments of the present invention have been shown and described above, it can be understood that the above embodiments are exemplary and cannot be understood as a limitation of the present invention. Ordinary technical personnel in the field may make changes, modifications, substitutions, and variations to the above embodiments within the scope of the present invention.

1. A method for preparing HoMOF materials, characterized in that the method comprises:
(1) Mixing the holmium source, organic ligand and solvent for ultrasonic treatment to obtain the first mixture;
(2) Placing the first mixture in the condensation reflux device for heating and stirring to obtain the second mixture;
(3) Post treating the second mixture to obtain HoMOF material.

2. The method according to claim 1, characterized in that the mole ratio of the holmium source, organic ligand and solvent mixture is in the range of (1.5˜2.5):(0.8˜1.2):(1˜5); And/or, the temperature of the ultrasound is 20˜30° C. and the time is 15˜30 minutes.

3. The method according to claim 1, in step (1), characterized in that the holmium source comprises holmium chloride hexahydrate or holmium sulfate octahydrate; Or, the organic ligands include one or more of terephthalic acid, 1,2,4-benzenetricarboxylic acid, phthalic acid, isophthalic acid and terephthalic acid.

4. The method according to claim 1, characterized in that the solvent comprises at least one of water and ethanol; And/or,
The solvent comprises water and N,N-dimethylformamide, wherein the dimethylformamide accounts for less than 80 wt % of the total mass of the water and N,N-dimethylformamide; the solvent comprises ethanol and N,N-dimethylformamide wherein the N,N-dimethylformamide accounts for less than 80 wt % of the total mass of ethanol and N,N-dimethylformamide.

5. The method according to claim 1, characterized in that the heating and stirring temperature is 90˜100° C. and the heating time is 12˜36 h.

6. The method according to claim 1, characterized in that the post-treatment comprises:
placing the second mixture into a filter, filtering and washing it with deionized water, and then drying it in a vacuum drying oven at 100˜120° C. for 3˜6 h.

7. A HoMOF material, characterized in that the HoMOF material is prepared using the methods claimed in claim 1.

8. A HoMOF material, characterized in that the HoMOF material is prepared using the methods claimed in claim 2.

9. A HoMOF material, characterized in that the HoMOF material is prepared using the methods claimed in claim 3.

10. A HoMOF material, characterized in that the HoMOF material is prepared using the methods claimed in claim 4.

11. A HoMOF material, characterized in that the HoMOF material is prepared using the methods claimed in claim 5.

12. A HoMOF material, characterized in that the HoMOF material is prepared using the methods claimed in claim 6.

13. The HoMOF material according to claim 7, characterized in that the pore volume of the HoMOF material is 0.05˜0.13 cm³/g, the specific surface area is 51˜135 m²/g, and the average pore size is 2.33˜12.57 nm.

14. An application of HoMOF material as claimed in claim 7, characterized in that the application comprises adsorption removal of methylene blue from waste water.

15. An application of HoMOF material as claimed in claim 8, characterized in that the application comprises adsorption removal of methylene blue from waste water.

16. An application of HoMOF material as claimed in claim 9, characterized in that the application comprises adsorption removal of methylene blue from waste water.

17. An application of HoMOF material as claimed in claim 10, characterized in that the application comprises adsorption removal of methylene blue from waste water.

18. An application of HoMOF material as claimed in claim 11, characterized in that the application comprises adsorption removal of methylene blue from waste water.

19. An application of HoMOF material as claimed in claim 13, characterized in that the application comprises adsorption removal of methylene blue from waste water.

20. The application according to claim 9, characterized in that the concentration of the methylene blue solution is 2˜2000 ppmw.
